(19) United States
(12) Patent Application Publication
(10) Pub. No.: US 2026/0022816 A1
(43) Pub. Date: Jan. 22, 2026

(54) MULTISPECTRAL ILLUMINATOR

(71) Applicant: Innovations In Optics, Inc., Woburn, MA (US)

(72) Inventors: Thomas J. Brukilacchio, Reading, MA (US); David W. Pierce, Reading, MA (US); Trevor Baker, Medway, MA (US)

(21) Appl. No.: 19/270,748

(22) Filed: Jul. 16, 2025

Related U.S. Application Data
(60) Provisional application No. 63/673,976, filed on Jul. 22, 2024.

(51) Int. Cl. F21V 5/00; F21V 7/00; F21V 9/02; F21V 29/54; F21Y 105/18; F21Y 113/17; F21Y 115/10

(52) U.S. Cl. CPC F21V 5/008; F21V 7/0083; F21V 9/02; F21V 29/54; F21Y 2105/18; F21Y 2113/17; F21Y 2115/10

(57) ABSTRACT

A multispectral illuminator includes an array of tapered non-imaging collection optics, a plurality of arrays of LED die and a lens system. Each tapered non-imaging collection optic has an input face and an output face. Each LED die has an optical spectrum and is disposed proximate to one of the input faces. The lens system is configured to receive light emitted from the output faces and to generate a composite image at an illumination plane. The composite image includes a superposition of the images of each output face. A control module controls the intensities of the LED die and may be programmed to provide a predetermined optical spectrum for the composite image. In some embodiments, the tapered non-imaging collection optics are configured to compensate for keystone effect and intensity gradient in the images of the output faces.

### RELATED APPLICATION

This application claims the benefit of the earlier filing date of U.S. Provisional Patent Application No. 63/673,976, filed Jul. 22, 2024 and titled “Multispectral Illuminator,” the content of which is incorporated herein by reference in its entirety.

### FIELD OF THE INVENTION

The invention relates to high spatial and spectral uniformity illumination systems using solid state light sources such as Light Emitting Diodes (LEDs) characterized by a compact design with attributes including low cost, high stability and reliability, long life, and a broad spectrum with independent control of all wavelengths. Embodiments of the multispectral illuminator described herein have all those attributes and have applications in solar simulation, hyperspectral and multispectral imaging, among many others.

### BACKGROUND

Devices that convert solar energy directly into electrical power represent an important part of renewable energy technology and are being used the world over, even in space-borne applications. Such devices include solar panels which may be located on the tops of residential and commercial buildings and in fields generally referred to as solar farms. Many material systems including, but not limited to, various types of silicon based devices, cadmium telluride, perovskite, and gallium arsenide, have been developed in single and multiple junctions with conversion efficiencies in the range of several percent to over 40 percent. As solar cell efficiencies continue to improve and be produced in higher quantities, the need for solar simulators of high uniformity and stability increases to help researchers and developers design improved performance solar cells and panels.

The standard for many years in solar simulators used xenon arc lamps as the light source to simulate the spectrum of the sun. Xenon arc lamps have a correlated color temperature (CCT) that is close to that of the sun at around 5700 Kelvin. This makes xenon arc lamps a good choice as solar simulators, however, some electronic transitions in the Near Infrared (NIR) are significantly filtered out and cause the xenon spectrum to deviate appreciably from the solar spectrum. Other issues with xenon lamps include poor lifetime, low conversion efficiency from electric to optical power and a continuous decrease in light output requiring frequent calibrations.

There is a critical need for solar simulators characterized by low cost, high stability, long life, and high spatial and spectral uniformity that can meet the needs of the latest broad spectral band solar cell technologies. These solar simulators will continue to play a critical role in the development of solar cell technologies with improved lifetime and efficiency, which is critical to widespread adoption. The incremental improvements in solar cell technology require the high stability, lifetime and uniformity that can be achieved by LED based solar simulators and in particular by the novel multispectral illumination invention herein, as applied to a solar simulator. The need of the industry generally precludes the use of xenon lamp technology, that suffers from short life, significant drift in intensity, and high energy use since only a few percent of the energy to power the lamps is converted to the desired spectrum.

There are two basic types of solar simulators. One type is generally used for simulating the sun over large solar panels that can be more than one meter per side. This type of solar simulator, typically referred to as a solar soaker, is made of multiple LEDs grouped in a tile format without any secondary optics other than encapsulation and mirrors on the sides to extend the useable area. This approach is well suited for illumination of large solar panels. The other type of solar simulator is based on projection technology for which multiple LEDs are used to image a specified area at a distance from the light source. This is important when illuminating small solar cell test coupons in a research and development system where hundreds or even thousands of coupons are illuminated at a time but require electronics and thermal control elements that require space and therefore preclude the use of solar soaker technology. Additionally, windows between the solar simulator and solar test coupon can sometimes be required to simulate different ambient temperatures over a broad range. If projectors were not used, the efficiency would be poor since solar soakers fall off in intensity quickly with distance. Projection based solar simulators inherently require some type of imaging system to provide a high uniformity region just over the device under test and not largely overfilling the device, which would lead to poor efficiency and high energy use.

There are several projection-based LED solar simulator systems on the market. Relative to the present invention, these systems suffer from one or more of the following: small active area of high uniformity, smaller number of unique spectral wavelengths resulting in increased spectral deviation, shorter lifetime, greater drift of intensity, slow pulsed response, narrower spectral coverage, and higher cost.

### SUMMARY

A multispectral illuminator includes an array of tapered non-imaging collection optics each having an input face and an output face and, for each of the tapered non-imaging collection optics, an array of LED die disposed proximate to the input face, wherein each LED die has an optical spectrum. The multispectral illuminator further includes a lens system configured to receive light emitted from the output faces of the tapered non-imaging collection optics and to generate a composite image at an illumination plane. The composite image includes an image of each output face at the illumination plane wherein the images are superimposed on each other.

The multispectral illuminator may further include a control module in communication with the arrays of LED die, the control module configured to control an intensity of each LED die, or pairs of diametrically-opposite LED die. The control module is programmable to provide a predetermined optical spectrum for the composite image and may include one or more current drivers to supply an electrical current to the LED die.

For each array of LED die, the optical spectrum of at least one of the LED die may be different from the optical spectrum of at least one other LED die in the array. Conversely, for each array of LED die, all of the LED die may have the same optical spectrum.

The lens system may include at least one lens array disposed proximate to the output faces of the array of tapered non-imaging collection optics and may be configured to image each of the output faces to infinite. The lens system may further include at least one lens disposed to receive light from the at least one lens array and to generate the composite image at the illumination plane. The lens array may have a plurality of lenses each having an aspheric surface.

For each LED die in each array of LED die for a tapered non-imaging collection optic that is positioned off axis in the multispectral illuminator, the optical spectrum of the LED die may be the same as an LED die in the array of LED die for a diametrically-opposite one of the tapered non-imaging collection optics.

The array of tapered non-imaging collection optics may be a hexagonal array.

The array of tapered non-imaging collection optics may be centered on an illuminator axis and each tapered non-imaging collection optic may have a taper axis extending between and orthogonal to the input and output faces, wherein, for each of the tapered non-imaging collection optics that is offset from the illuminator axis, a center of the input face is laterally offset from the taper axis. The output face for each of the tapered non-imaging collection optics that is offset from the illuminator axis may have a trapezoidal shape. The lateral offset of the center of the input face from the taper axis may be determined by the amount of the offset of the tapered non-imaging collection optic from the illuminator axis.

The array of tapered non-imaging collection optics may be centered on an illuminator axis and each tapered non-imaging collection optic may have a taper axis extending between and orthogonal to the input and output faces, wherein, for each of the tapered non-imaging collection optics that is offset from the illuminator axis, a center of the output face is laterally offset from the taper axis. The output face for each of the tapered non-imaging collection optics that is offset from the illuminator axis may have a trapezoidal shape. The lateral offset of the center of the output face from the taper axis may be determined by the amount of the offset of the tapered non-imaging collection optic from the illuminator axis.

At least one of the tapered non-imaging collection optics may be a hollow tapered non-imaging collection optic. The hollow tapered non-imaging collection optic may include a high reflectance surface.

At least one of the tapered non-imaging collection optics may be formed of a molded plastic. At least one of the tapered non-imaging collection optics may be formed of an ultraviolet transmitting material.

### BRIEF DESCRIPTION OF THE DRAWINGS

The structure, operation, and methodology of the invention, together with other objects and advantages thereof, may best be understood by reading the following detailed description in connection with the drawings in which each part has an assigned numeral or label that identifies it wherever it appears in the various drawings and wherein:

FIG. 1 shows a diagrammatic isometric view of a multispectral illuminator system.

FIG. 2 shows a diagrammatic isometric cross-sectional view of the system of FIG. 1 showing internal optical components.

FIG. 3A shows a comparison between AM0 and AM1.5 Global Solar Spectrums.

FIG. 3B shows a spectral intensity plot of a preferred embodiment of the system of FIG. 1 compared to the AM1.5 Global Solar Spectrum.

FIGS. 4A to 4C show sequential optical ray traces of the primary optical components from LEDs to an illumination plane for three object points and FIG. 4D shows the sequential optical ray traces for FIGS. 4A to 4C indicating how each of the images of the output faces of the tapers are imaged to be superimposed at the illumination plane.

FIGS. 5A to 5D show non-sequential optical ray traces through the primary optical components from LEDs to illumination plane for all object points.

FIG. 6A shows a diagrammatic isometric view of the optical train, LED board, and thermoelectric cooler portion of the system of FIG. 1. FIG. 6B shows a diagrammatic isometric cross-sectional view of the system of FIG. 6A.

FIG. 7 shows a diagrammatic isometric view of the first three elements of the optical system of FIG. 6A.

FIG. 8 shows a diagrammatic isometric cross-sectional view of the system of FIG. 7 cut through the solid tapered non-imaging optics.

FIG. 9 shows a diagrammatic cross-sectional view of the system of FIG. 7.

FIG. 10 shows a diagrammatic isometric cross-sectional view of the system of FIG. 7 cut through the hollow tapered non-imaging collection optics.

FIG. 11A shows a diagrammatic isometric view of a hollow taper pair assembly of the system of FIGS. 1 to 8. FIG. 11B shows one of the two identical pairs of hollow tapered non-imaging optics.

FIG. 12 shows a diagrammatic isometric view of the molded solid taper assembly.

FIGS. 13A and 13B, respectively, show bottom and top views of the taper assembly of FIG. 12.

FIG. 14 shows a cross-sectional view of the taper assembly of FIG. 12.

FIGS. 15A and 15B, respectively, show a diagrammatic isometric view and cross-sectional view of the lens array proximal to the taper array of the system of FIG. 9.

FIG. 16A shows a diagrammatic isometric view of the second lens array of the system of FIG. 2. FIGS. 16B and 16C show an isometric cross-sectional view and a cross-sectional side view, respectively, of the second lens array of FIG. 16A.

FIG. 17 shows a top view of the LED printed circuit board of the system of FIG. 1.

FIGS. 18A and 18B show, respectively, a diagrammatic isometric view of two LED arrays of the LED printed circuit board of FIG. 17, and a top view of the same LED printed circuit board for one LED array.

FIG. 19 shows a diagrammatic isometric view of the LED printed circuit board of FIG. 17 and the mated solid taper assembly of FIG. 12.

FIG. 20A shows a non-sequential ray trace of another embodiment with one proximal lens and an array of 37 tapers. FIG. 20B shows the resulting intensity distribution and FIG. 20C shows a plot of intensity along the X axis of the intensity distribution of FIG. 20B.

FIG. 21A shows the details in side-on view and top view of one of the symmetric tapers of the embodiment of FIG. 20A. FIG. 21B shows the details of a side-on and top view of an asymmetric taper.

FIGS. 22A and 22B show, respectively, a non-sequential ray trace according to an alternative embodiment to that shown in FIG. 20 which incorporates the asymmetric taper of FIG. 21B. FIGS. 22C and 22D, respectively, show an intensity image and a cross-sectional plot of the improved performance resulting from the asymmetric taper.

FIG. 23 shows an 8×8 grid intensity plot of the image of the multispectral illumination system of FIG. 1.

### DETAILED DESCRIPTION

Multispectral illuminators described herein use an array of LEDs or an array of LED arrays spread out spatially for the purpose of reducing heat flux, thereby decreasing LED junction temperature and improving lifetime. Alternatively, the improved performance can be used to provide higher intensities. Additionally, this geometry makes wire bonding the LED die more manufacturable such that no wire bonds cross over any other LED die, thereby reducing the likelihood of one die shorting to another and also eliminating the loss in efficiency due to light blocked by wire bonds, thereby improving reliability, efficiency, and lifetime. Existing systems use a single tapered non-imaging collection optic (also referred to herein as a “tapered collection optic” or “taper”) to efficiently capture the output of the LED die, convert it to a smaller far field angle that can be effectively and efficiently imaged by a lens system and imaged with high uniformity onto the illumination plane where the solar test coupon would be positioned. While from the optical standpoint this approach works very well, the close proximity of all the LED die results in higher junction temperatures, thereby decreasing lifetime relative to the approach of the present invention in which the LED heat sources are spread over a larger area, resulting in lower heat flux into the heat sink and thereby decreasing junction temperature of the LED die and improving lifetime.

To spread out the LED heat sources most effectively, the system of the present invention positions the LED die in a hexagonal close-packed array of individual LED die or close-packed array of individual arrays of LED die as will become clear from the detailed description below. The optimal approach of using a tapered non-imaging collection optic is used, but in an array of multiple tapers (i.e., a “taper array”) instead of a single taper geometry. Hexagonal close-packed arrays of 7, 19, 37, 61, etc., are the most efficient and result in the most compact, cost-effective approach with the smallest overall system size. Deviating from a close-packed configuration is feasible, but not optimal.

The optical system can be understood by considering an individual LED die or die array and its tapered collection optic, along with other optical components to image the output of the taper to the illumination plane. The light from the LEDs is efficiently captured at the input aperture of the tapered non-imaging collection optic. As the light traverses down the tapered optic, it is spread out spatially and decreases in angular extent such that the output is highly spatially uniform at the output face of the taper even for multiple LED sources at the input aperture of the taper. A lens system receives the LED light emitted from the output face of the taper and generates an image at the illumination plane where the solar cell test coupon is positioned. The longer the taper length relative to the dimensions of the input and output faces, the better the uniformity of intensity in the near field, that is, at the location of the output face of the taper. Optical nonsequential ray tracing software such as ZEMAX®, TRACEPRO®, Light Tools®, etc., can be used to model the system to determine the required taper length for a given uniformity requirement. The taper alone, however, is not responsible for high uniformity. The lens system is configured to result in high uniformity to preserve the degree of uniformity at the output of the taper with no vignetting. A level of desired uniformity is achieved by trading off various parameters, including, by way of example, material types to address chromatic aberrations, numerical aperture, lens size, thickness, spectral transmission, and the number of optical elements. Since the application is illumination and not high-resolution imaging, it is desirable to optimize the uniformity of intensity over a specified active area. The best results are achieved by favoring uniformity of intensity over modulation transfer function (MTF) or spot size, to achieve the best spatial intensity uniformity with the smallest number of optical elements for cost optimization.

Each of the tapers in the array has its own imaging lenses. For a symmetric optical system, this configuration results in the center of each taper/lens system, to have an image centered on the LED die or LED die array of each element such that the images of the taper outputs do not fully overlap within the composite image. Thus, the composite image has poor overall uniformity and poor color mixing at the edges. The present invention solves this issue by imaging each of the individual lens systems to infinite and recognizing that a lens or group of single lenses that capture light from the entire array of LED/taper/lens projectors is imaged in closer, that is, to the desired working distance and such that all images overlap at the same distance. Since different wavelength LEDs, i.e., LEDs having different optical spectra, can be used for each of the different tapers, the composite image is multispectral and characterized by high uniformity. In a preferred embodiment detailed below, there are nineteen individual tapers in a hexagonal close packed arrangement, with each LED taper input face disposed proximate to a two-by-two array of LED die of approximately one millimeter on a side. The input face, i.e., the taper input aperture, has dimensions on the order of two-by-two mm. This results in a composite image of fifty-by-fifty millimeters. Different magnifications can be used to achieve different active areas; however, consideration should be made to achieving the required sun levels for larger apertures by providing more optical output from each LED die. Furthermore, it should be apparent to those skilled in the art that a larger array, for example, a hexagonal close pack of thirty-seven array elements could be used to have the same power per LED die but achieve a larger active area.

The solar spectral extent required to cover the gamut of solar cell absorption spectra extends from about 320 nm in the UVB region to about 1500 nm in the NIR. Recently, newly available LEDs in the UVB and higher efficiency LED die in the longer NIR have become available and can be adapted to the present invention. Careful attention, however, must account for the absorption properties of molded plastics and glasses and standard glasses for lenses. For example, most glasses absorb in the UVB range of 320 nm to 380 nm, so if the UVB wavelengths are used, materials such as fused silica that readily transmit with minimal absorption in the UVB spectrum can be used. Typically, these materials cost more than standard glasses, so system cost is optimized for a specific range of spectral coverage to suit the requirements of a given solar simulator. Additionally, optical plastics have strong absorption in the region of 1200 nm such that a plastic molded taper does not work effectively. In that case, hollow tapers for the NIR coated with high reflectivity coatings to address this issue can be used.

A multispectral illuminator, as described in embodiments below, comprises an array of LED die or LED die arrays disposed proximate to an array of tapered non-imaging collection optics and associated downstream lenses to image the output of individual tapers, with common lenses following the array elements to converge all array element images to a common image. This composite image is the combination of the individual images of a multitude of specific optical spectrum LEDs to result in a broad spectrum, closely matching that of the sun with numerous applications including solar simulators.

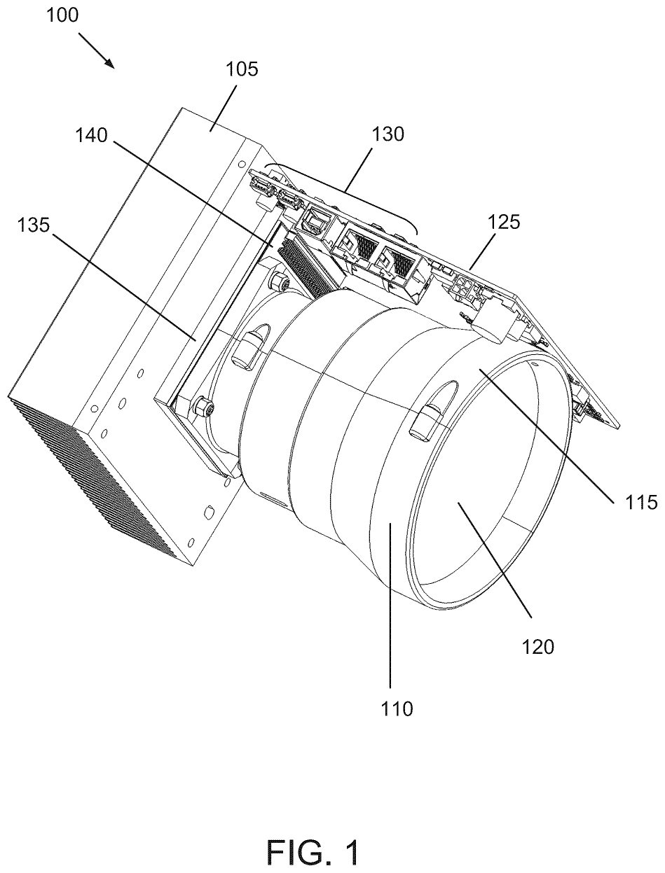

Referring to FIG. 1, there is shown a diagrammatic isometric view of an embodiment of a multispectral illuminator 100. A metal core printed LED circuit board 140 is in communication with a control module that is configured to control an intensity of each LED die. The control module includes a current controlled driver 125 that electrically couples to the LED circuit board 140 through a board-to-board connector, both to save space and reduce cost associated with a cable assembly. The back side of the LED board 140 is attached to thermoelectric Peltier cooler (TEC) interface plate 135 with a low thermal impedance thermal interface material (TIM) such as pyrolytic graphite to assure good thermal contact and minimal temperature rise over the interface. The TEC interface plate 135 does not make direct thermal contact with heat sink 105. Similar TIMs are used on the top of the TEC and bottom of the TEC in direct contact with the heat sink 105. The two-part optics housing 110 and 115 contain and align the internal non-imaging and imaging optics for which only the outer lens 120 is visible. The housing can be made of plastic or metal and in preferred embodiments is made of cast aluminum or zinc. Metals have lower thermal expansion relative to plastic and so result in more stable thermal performance. Alternatively, composite glass filled plastics can be used to minimize thermal expansion considerations and reduce system weight. The dimensions of the module are approximately 120 mm wide, by 120 mm tall, by 149 mm in length along the direction of the optical axis. The working distance to the illumination plane is approximately 132 mm. The diameter of lens 120 is 91 mm.

The requirements for pulsed applications include a large dynamic range of intensity and low noise characteristics making linear current drivers a preferred implementation for the control module. Driver 125, in one preferred embodiment, is a 38 channel, linear current controlled driver with industry standard +24 VDC input. Communication is by USB serial or RS-485 through I/O connectors 130. LED die with optical spectra ranging from UVB near 320 nm or UVA near 365 nm, and extending up to 1500 nm in the NIR or higher, represent a large range of voltage requirements, typically on the order of 5V for UVB and on the order of IV for the longer NIR. In some implementations, all the LED die in a LED die array for a single tapered non-imaging collection optic have the same optical spectrum while, in alternative implementations, at least two of the LED die in the LED die array have different optical spectra. In a preferred embodiment for a system covering the spectrum between 350 nm in the UVA and 1250 nm in the NIR, the LEDs are grouped and matched to 3 different power supplies on the basis of their maximum operational forward voltages. The driver 125 is configured to measure the voltage required to achieve any sun intensity level as a self-calibration routine. One of the drawbacks of linear current drivers relative to switching drivers is lower efficiency, since the current is regulated by a metal-oxide-semiconductor field-effect transistor (MOSFET) the power supply is generally a fixed DC current. The difference in voltage between the forward voltage of the LED at the required drive current and that of the DC power supply is dropped by the MOSFET and represents a power loss. The advantages of linear drive circuits include high short-term and long-term current stability, low cost, low noise, and fast rise times required of many pulsed illumination products. By employing unique feedback to the otherwise constant DC power supplies, the voltages of the power supplies can be lowered to a value just larger than that required by the LEDs such that the linear current drivers become more efficient, largely overcoming their one drawback. Consequently, the driver can be lower cost, more compact and have improved reliability.

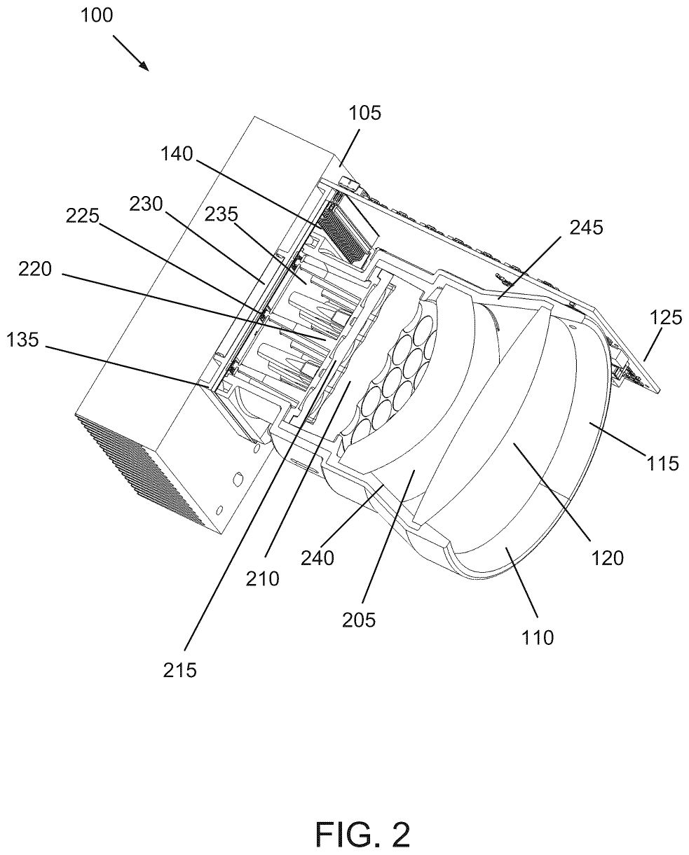

Referring now to FIG. 2, there is shown a diagrammatic isometric cross-sectional view of FIG. 1 exposing the internal optical train and TEC. A two-by-two LED array 225 is shown proximate to the input face of one of the tapers 220 of the taper array. Proximate to the output faces of the tapers 220, a first lens array 215 is shown followed proximally by a second thicker lens array 210. In an alternative embodiment, a single lens array is used with each of the lenses in the lens array having an aspheric surface. Proximal to the second lens array 210, a concave-convex lens 205 is shown, followed by an outer convex-convex lens 120. The three molded elements, 220, 205, and 120 reference to each other at their outer edges and are centered in the housing by a pair of silicone liners 240 and 245 and take up compliance due to both manufacturing tolerances and thermal expansion and contraction. Element 235 is shown near the input apertures of the taper array and has the purpose of forcing the alignment of the tapers 220 to the LED die arrays and minimizing any potential drift with temperature. The TEC 230 is shown sandwiched between the TEC interface plate 135 on the top side and the heat sink 105 on the lower side with TIMS on both interfaces as described above. The TEC dimensions are the order of 40 mm square by 3.9 mm thick, for example Laird part number ETX6-19-F1-4040-TA-RT-W6 (available from Tark Thermal Solutions of Morrisville, NC). The purpose of the TEC 230 is twofold, firstly, it maintains the LED die at a constant temperature since LEDs shift their peak wavelength as a function of LED junction temperature, and secondly, the junction temperature can be controlled to a lower temperature than for a standard heat sink alone. The lifetime of LEDs is a function of both current density and junction temperature for continuous operation, so lowering the LED junction temperature by use of the TEC 230, the lifetime of the system is improved. LEDs are known to improve in lifetime by about a factor of two for every ten degrees Celsius decrease in junction temperature, so even a few degrees decrease has a measurable effect on lifetime. Another aspect of the TEC 230 is that in the event of high ambient temperature and high humidity, the TEC 230 can be controlled to a higher temperature to prevent condensation on the optics which could affect intensity and uniformity. Any number of TEC temperatures can be calibrated in, so that the output of the system does not change with a fixed known change in TEC set point temperature.

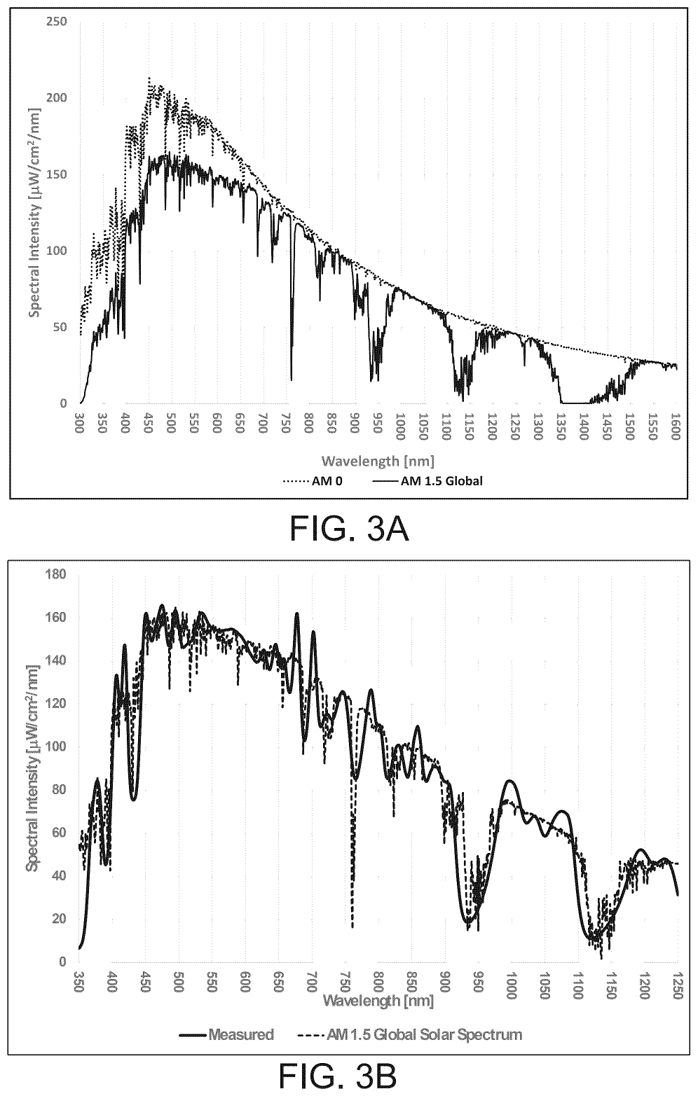

It is instructive to show the solar spectrum that the multispectral illuminator is simulating in the case of solar applications to motivate the selection and number of distinct LED optical spectra. FIG. 3A shows the AM0 and AM1.5 Global reference solar spectrums. The AM0 solar spectrum represents solar light in spaceborne applications for which there is no absorption by the atmosphere. The AM1.5 Global spectrum is the standard terrestrial reference for solar simulators. The variations (“dips”) in the spectrum relative to that of the AM0 are caused by absorption of gases and water in the atmosphere. The difference for shorter wavelengths is dominated by Rayleigh scattering which increases by the fourth power of frequency, or inversely as the fourth power of the wavelength, and so is more pronounced in the blue and UV portions of the spectrum. FIG. 3B shows the measured spectrum of the system of FIG. 1 in black relative to the AM1.5 Global solar spectrum represented by the gray line. By proper programmed operation of the control module described above with respect to FIG. 1, the dips in the solar spectrum and the general Plank distribution of the solar spectrum can be closely matched. This includes controlling the intensities associated with the multiple optical spectra to achieve a predetermined optical spectrum for the composite image in the illumination plane. Spectral deviations on the order of 10% can be achieved, as specified by International Electrotechnical Commission (IEC) 60904-9 international standard for classification of solar simulator characteristics. In a preferred embodiment, 35 different LED optical spectra are used.

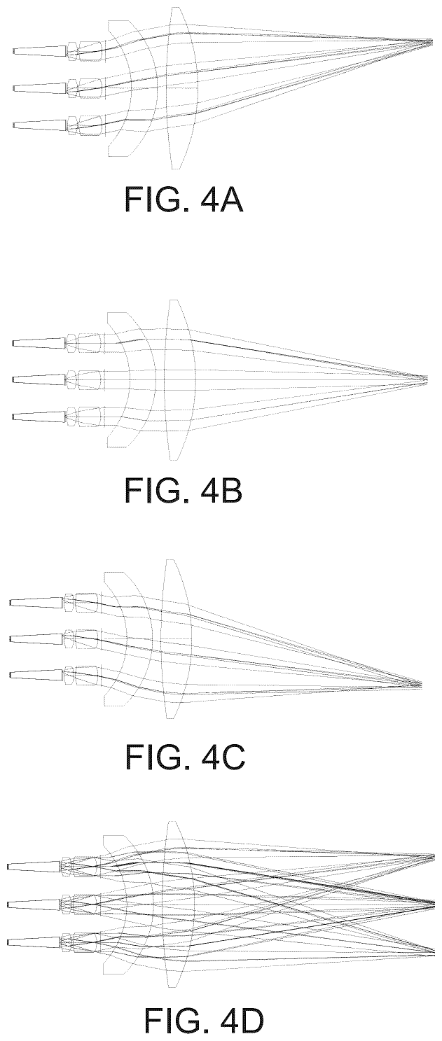

FIGS. 4A to 4D represent sequential ray traces from the output of the taper from the same field point of each taper to an image point where all outputs for a given field point converge to the same point on the illumination plane. For purposes of clarity, the tapers and LED arrays are shown in the figures. FIGS. 4A, 4B, and 4C represent field points at the bottom, center, and top of each taper output aperture, respectively, which image to the top, center, and bottom of the illumination plane. FIG. 4D shows all three field points on each of the taper outputs showing how all tapers image to a common image at the illumination plane, that is, the images of the output faces of the tapers are superimposed at the illumination plane. The light exiting the two lenses proximal to each taper output face is telecentric and imaged to infinite. This condition allows for the exiting light to be imaged by the two subsequent large focus elements represented by lenses 205 and 120 of FIG. 2, and to image to the same point, such that the square image at the illumination plane is the linear sum of all the individual images of each taper and corresponding lens array elements. The line to the right of the second small lens element and to the left of the concave-convex large lens element is the position of the system aperture stop for each array element.

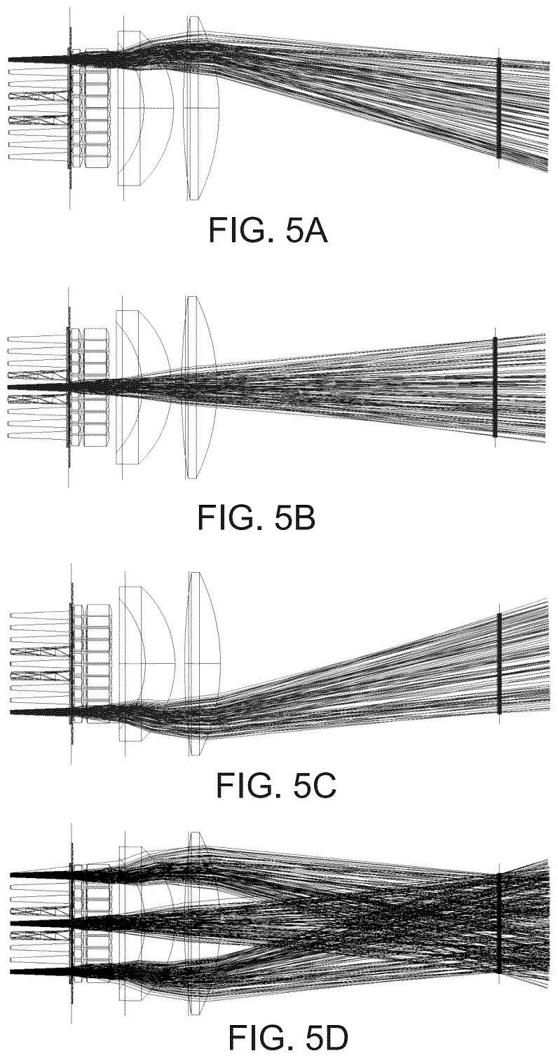

FIGS. 5A, 5B, and 5C represent non-sequential ray traces of a taper at the top, center, and bottom of the arrays, respectively, and forming an image of the taper output faces at the illumination plane corresponding to the optical system of FIG. 2. FIG. 5D shows all three tapers and their coincident images. In a preferred embodiment, the taper array is made of a UV transmitting (UVT) material such as UVT acrylic, and the two molded lens arrays are made of molded glass, LIBA 2000+. Since the two lens arrays are molded, aspheric lens surfaces can be readily produced which yield improved uniformity for fewer lens elements. Both surfaces of both lenses can have aspheric properties in a preferred embodiment. The two large single lenses, 205 and 120 can alternatively be replaced by a single molded glass aspheric lens; however, such a large, molded lens has a greater cost than the two conventionally ground and polished lenses 205 and 120. Moreover, two lenses provide four surfaces and two thicknesses for performance optimization, thus the standard lens approach can also substantially correct for spherical aberration. The choice of optical materials is driven by the range of wavelengths for a given application. For example, in a preferred embodiment covering the range from 350 nm in the UVA to 1250 nm in the NIR, the taper array exhibits good performance except for LEDs near 1200 nm for which all moldable plastics have a strong absorption band. So, for those wavelengths, hollow tapers are used with a high reflectance mirror coating on the inside walls of the taper. While it is feasible to use hollow tapers for all wavelengths except perhaps in the shorter UVA and UVB range where reflectivity of coatings is not as good generally, the solid taper array is more cost effective. Different wavelength ranges can require different mirror coatings which increases cost and complexity. UVB, however, down in the range of 320 nm to 345 nm does not transmit well even with a UV grade acrylic, so a high transmission solid taper made of a material such as fused silica can be used. A solid fused silica taper can be accommodated between the thin window of the taper assembly (of negligible absorption due to limited thickness) and is held and locked in place by element 235 of FIG. 2. Likewise, the molded glass of array lens elements 215 and 210 of FIG. 2 does not transmit the UVB acceptably. Therefore, any lens elements that transmitted UVB are cored out and replaced by a suitable lens element made of high UV transmission glass such as fused silica. The elements can also have aspheric surfaces like the glass elements they replace and can be made by the well-known process of magnetorheological finishing (MRF). While these material considerations do add cost and complexity to the system, the benefits of the extended spectrum are warranted in some applications.

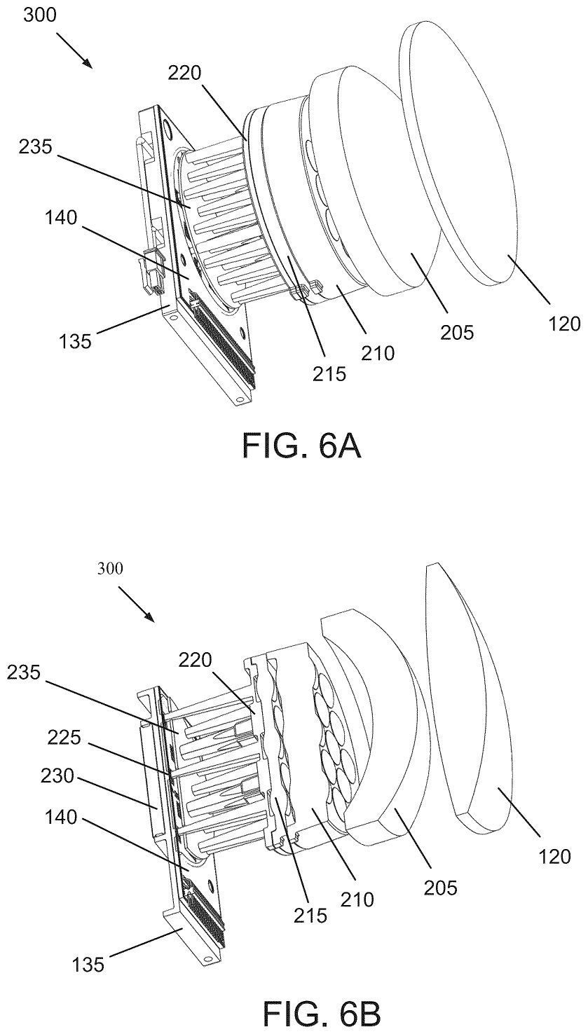

FIG. 6A shows a diagrammatic isometric view of an optical system 300 comprised of elements 220, 215, 210, 205, and 120 coupled to LED board 140 and attached to the TEC interface 135. FIG. 6B shows a cross-sectional view of the system 300 of FIG. 6A.

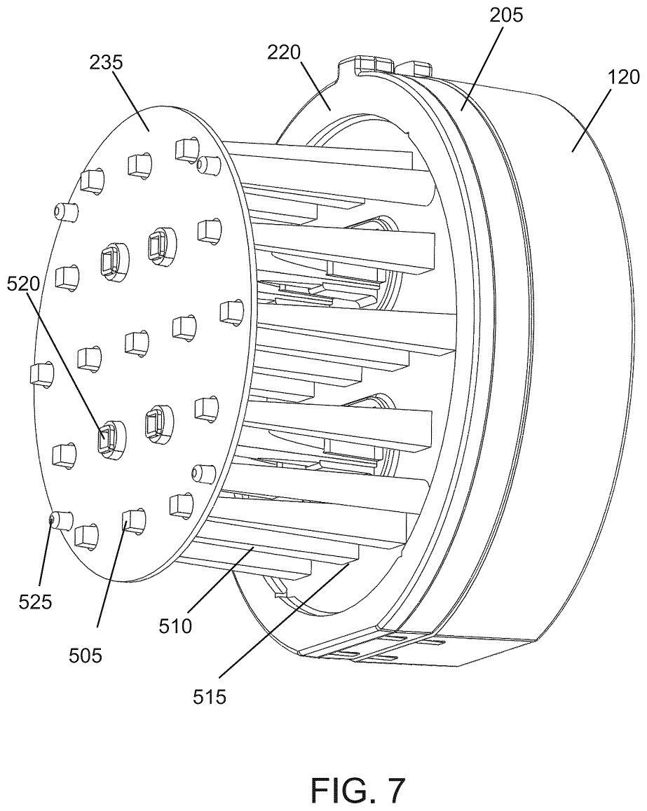

FIG. 7 shows a diagrammatic isometric view of the array elements 235, 220, 205, and 120. The input aperture 520 of one of the four hollow tapers is shown. The input apertures 505 of the solid tapers are coplanar with those of the hollow tapers. The gap between the top of the LED die and the input apertures of the tapers allows room for the wire bonds to be sufficiently close to the taper input to couple efficiently, typically in the range of 0.15 to 0.25 millimeters. This gap also accommodates manufacturing tolerances and thermal expansion considerations such that when the plastic gets hot, the tapers do not impact the LEDs or wire bonds due to differential expansion between the metal optic housing and the plastic tapers. This situation is unlikely to occur, however, since the standoffs of the taper are made of the same material as the tapers and thus expand at the same rate. The compliance of the silicone liners accommodates any small changes in plastic length relative to that of the metal housing. It is clear from this view that element 235 is used to align each of the taper inputs relative to the positions of the LED die. Centration of the optics to the LEDs is maintained by kinematic pins on the optic housing that mate to kinematic holes in the LED PCB. Also shown in this view is the middle portion 510 of a solid taper and the output aperture location 515 of that same taper, which are the same for all the other 14 tapers. There are four posts on the molded plastic taper with tips 525 that reference to the plane of the LED board to which the LEDs are attached to minimize tolerance stack up. The purpose of these posts is to space the input apertures at the correct distance from the LED output faces.

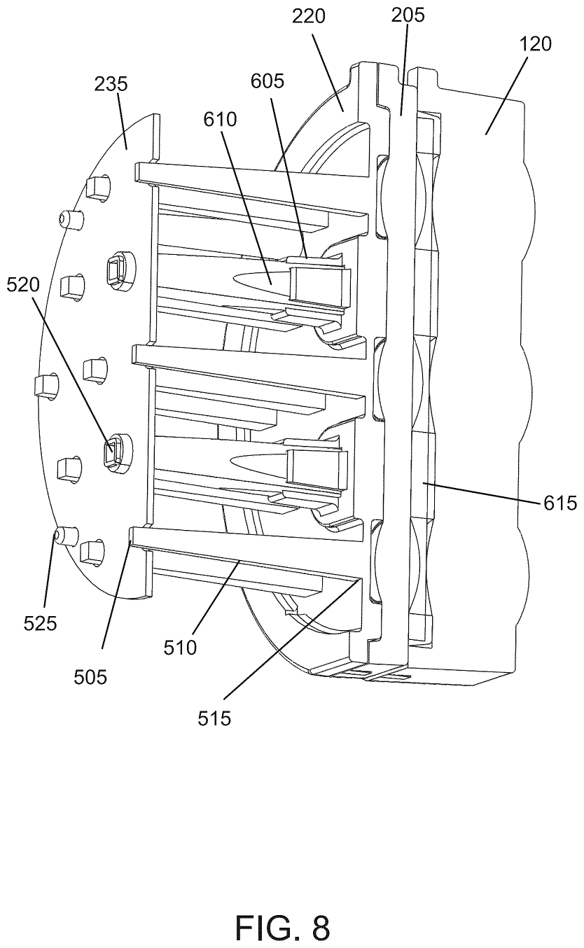

FIG. 8 shows a diagrammatic isometric cross-sectional view of the structure shown in FIG. 7. The view shows a slice through three of the solid molded tapers of taper array 220. Also shown are flexures 605, four each per hollow taper, that act to align hollow taper pair 610. Between lens arrays 205 and 120, a baffle 615 is shown. The baffle can be formed of an opaque material such as black foam or rubber. The baffle blocks any stray light that is not going through the circular apertures of the nineteen hexagonally close-packed individual lens elements that could result in uniformity issues at the illumination plane.

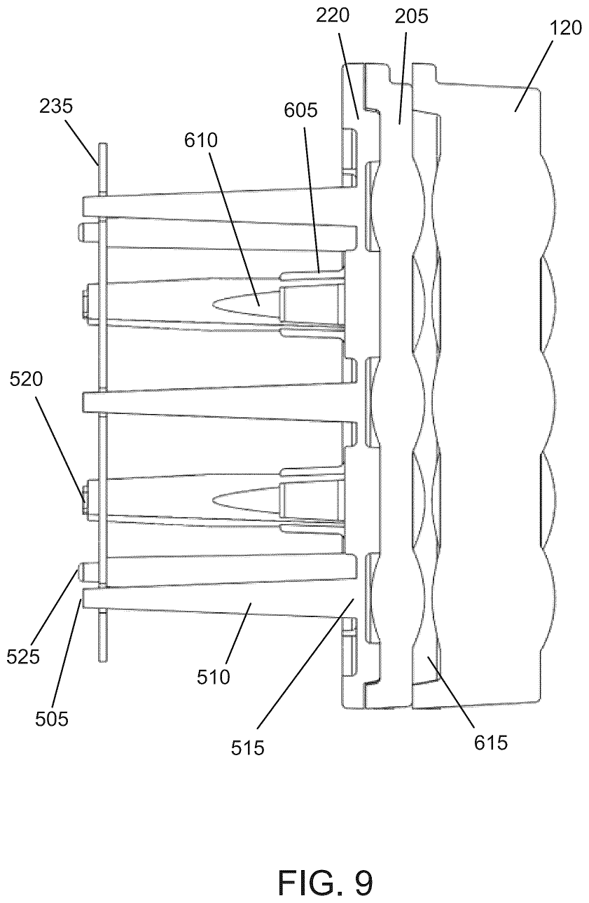

FIG. 9 shows a cross-sectional side view of the system of FIG. 7.

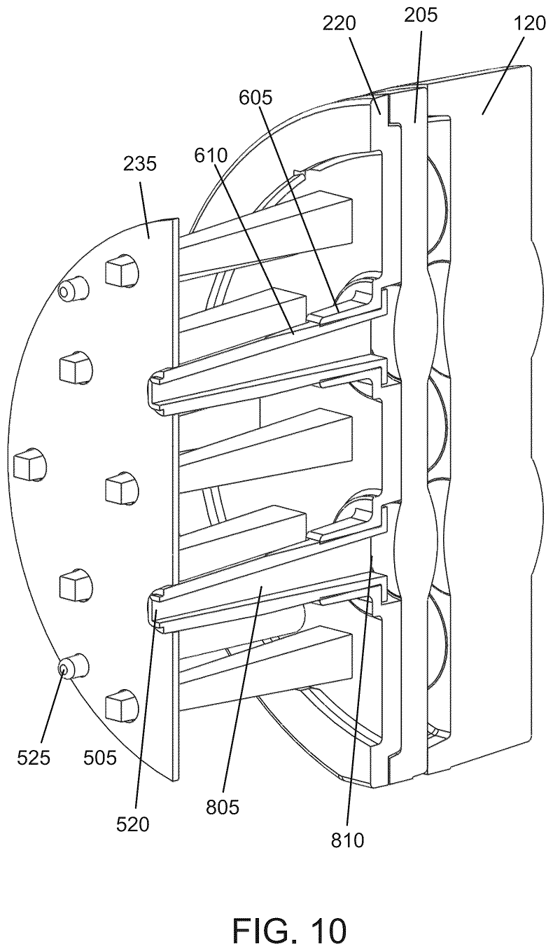

FIG. 10 shows a diagrammatic isometric cross-sectional view of the system of FIG. 7 through a plane centered on two of the hollow taper pairs 610. The center 805 of the hollow taper 610 is coated to form a high reflectivity mirror surface over the range of near grazing incidence to near normal incidence. The high reflectance surface results in low reflective loss through the taper 610. The output aperture 810 is imaged by elements of the two array lenses 215 and 210 and large common lenses 205 and 120 to the illumination plane.

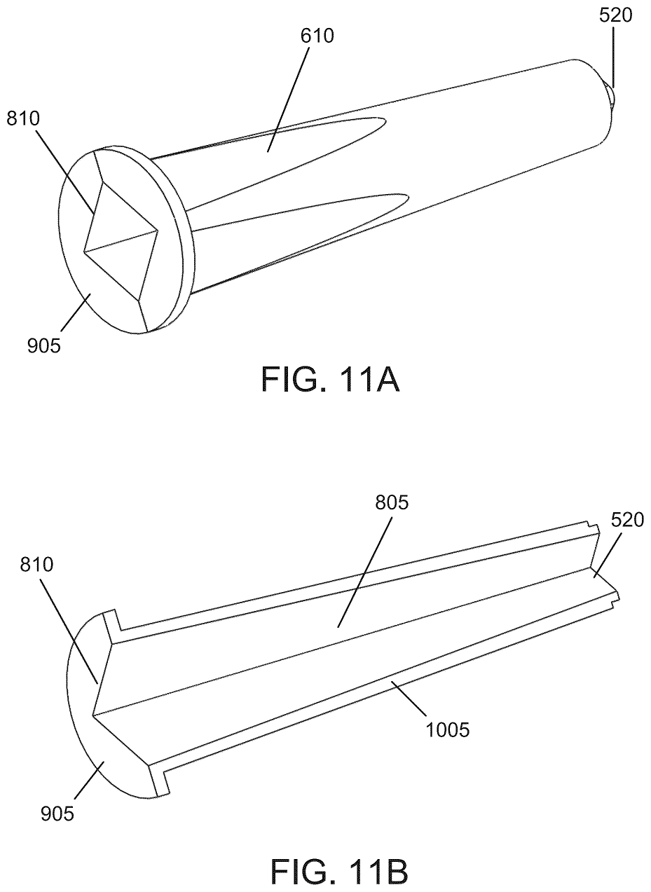

FIG. 11A shows a diagrammatic isometric view of a taper 610 (comprised of two taper halves) with input aperture 520, output aperture 810 and a flange 905 used for mounting to taper assembly 220. The flat regions on the sides enable alignment to the flexures on taper assembly 220. FIG. 11B shows a diagrammatic isometric view of a half taper with inside mirrored surface 805 on both inside surfaces and mechanical interface 1005 where the two identical halves are in contact to make a complete hollow taper. In a preferred embodiment, the input apertures of both the solid and hollow tapers measure 2.00 mm by 2.00 mm and the output apertures, 4.20 mm by 4.20 mm. The length of the hollow tapers are approximately 30 mm and similarly for the solid tapers. The material of the hollow tapers is clear polycarbonate. The mirror coating is enhanced silver for optimal performance in the NIR.

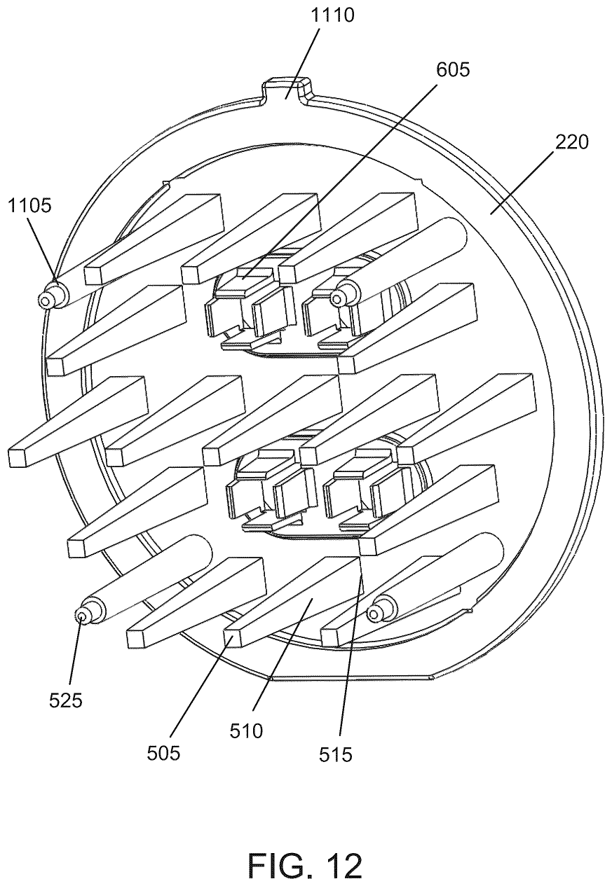

FIG. 12 shows a diagrammatic isometric view of the taper assembly 220. The fifteen solid molded tapers have an input aperture 505 on the order of 2.0 mm by 2.0 mm to each efficiently capture light from the associated two-by-two LED array for which the LED die are on the order of 1.0 mm on a side. The walls of each taper 510 are all symmetrically identical and at output face 515, which is the surface that is imaged onto the illumination plane. The flexures 605 which align the hollow tapers, four each per taper, are shown in four positions. The notch 1110 on the outside perimeter is for the purpose of keying the taper in rotation since the tapers need to be accurately aligned with the LED arrays. This key is also present in the two molded glass lens arrays and correspond to a notch in the optic housing half 110 of FIG. 1. The four individual pins include tips 525 that interface to the LED board 140 and shelf 1105 which is the stop and adhesive region for attaching the element 235 (see FIG. 10) which acts to force alignment of the tapers to the LEDs. The applied force prevents relative movement due to changes in temperature or if misaligned due to cooling shifts during manufacture of the plastic taper assembly. If the spectral range of a system does not extend out to wavelengths of 1200 nm or more, where plastics have a strong absorption band, the entire array of 19 tapers can be molded as solid tapers so that no hollow tapers are required. In a preferred embodiment, an ultraviolet grade of optical acrylic is used and includes a high transmission for the UVA LEDs in the 365 nm to 405 nm spectral range. For example, the material can be Acrylite H12-003 UVT.

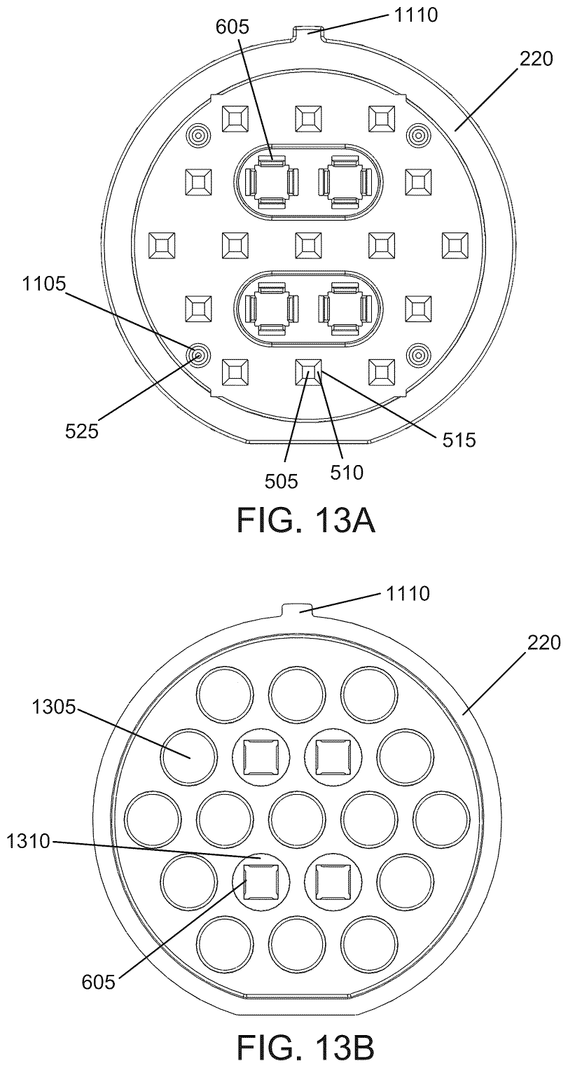

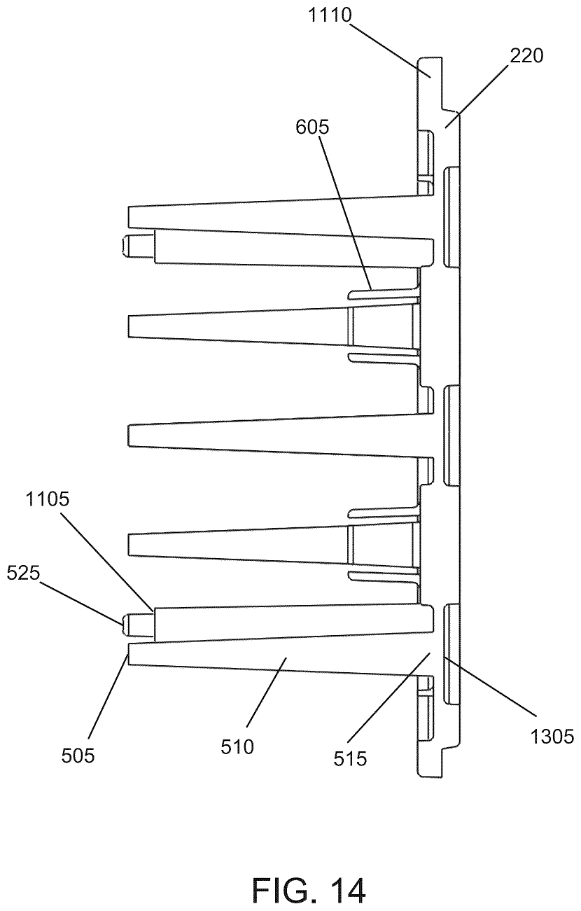

FIGS. 13A and 13B shows a bottom view and a top view, respectively, of the system of FIG. 12. The output windows 1305 are 1.0 mm from the output aperture of the tapers with the purpose of attaching the tapers to the taper array assembly. Additionally, since the output aperture is what is imaged onto the illumination plane, any slight imperfections or dust on the window 1305 has minimal effect since anything on the window is out of focus. The hollow tapers have a well with flat face 1310 which bonds to the bottom of the hollow taper flange 905 to attach the hollow taper to the taper assembly 220. FIG. 14 is a cross-sectional view of the system of FIG. 12 and shows a clear view of the window 1305 which attaches the tapers to the frame of the taper assembly 220.

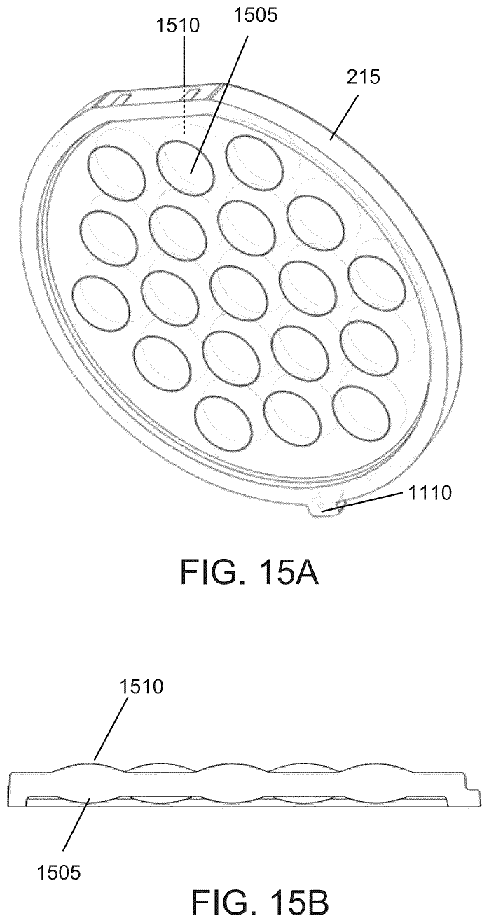

FIGS. 15A and 15B show a diagrammatic isometric view and a cross-sectional side view, respectively, of the first lens array 215 of FIG. 2 with input and output lens surfaces 1505 and 1510, respectively. In a preferred embodiment the first lens array 215 is made of LIBA-2000+ glass with both surfaces of each lens in the array being aspheric. The tapers and lenses are closely-packed center-to-center and are arranged in a hexagonal close pack geometry to minimize overall size and system far field angle at the illumination plane. If a given application does not require UVA wavelengths or extend out to 1200 nm in the NIR, then the lens array 215 can be made from the same acrylic molded plastic for reduced system cost.

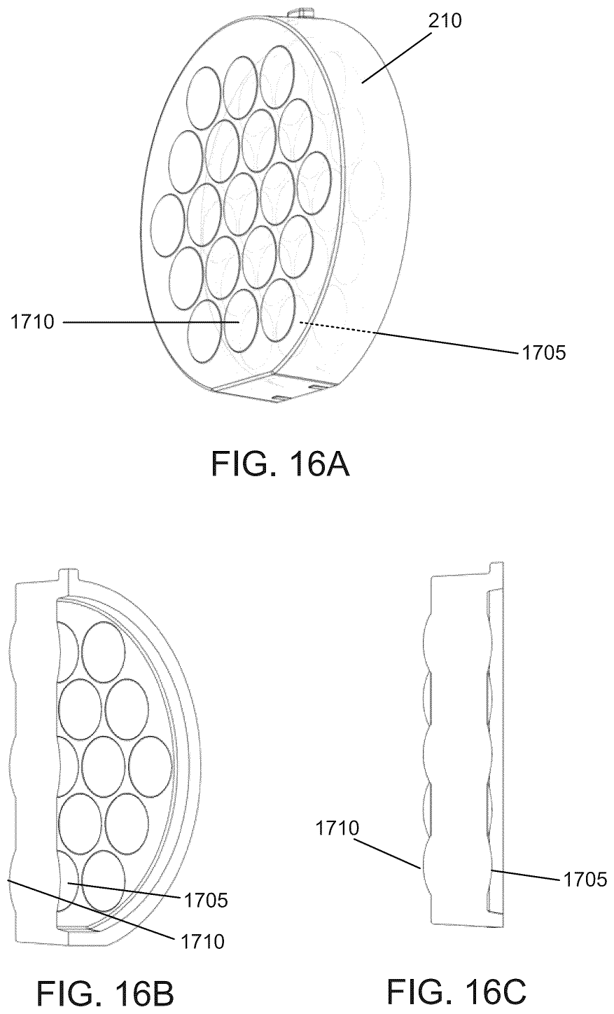

Similarly, FIG. 16A shows a diagrammatic isometric view of molded lens array 210 with first lens surface 1705 and second lens surface 1710. This lens array 210 is made of the same material as lens array 215 of FIG. 15A. FIGS. 16B and 16C show diagrammatic isometric and side cross-sectional views, respectively, of the system of FIG. 16A.

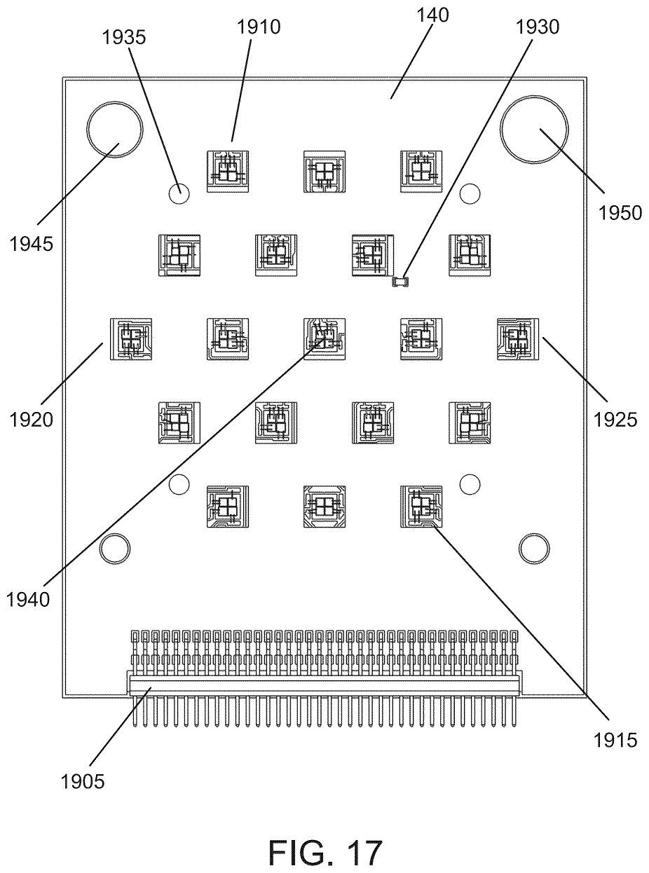

FIG. 17 shows a top view of the LED printed circuit board 140 of FIG. 2. In a preferred embodiment, there are nineteen arrays of two-by-two LED die arranged in a hexagonal close packed geometry. To address the keystone and intensity slope for off axis projector elements, the LEDs are arranged such that for each LED of a given optical spectrum, an LED of the same optical spectrum is provided in a diametrically-opposite position. In this way, the small amount of keystone and intensity slope cancels out to result in high uniformity for all positions. Of course, for the center array element 1940, there is no keystone or intensity slope. By way of example, LED array elements 1910 are balanced by similar optical spectrum LEDs in LED array element 1915, LED array elements 1920 are balanced by LED array elements 1925, etc. The four circular areas denoted by 1935 represent the position where the taper array 220 pins touch to control the gap between the LED die and the input aperture of the tapers. This is the same metal foil surface that the LED die are soldered to in order to minimize tolerances that can otherwise exist if the taper assembly were to reference to the top of the solder mask instead. A thermistor 1930 is located on the LED board to monitor and close the loop on the TEC temperature controller. The TEC controller is integrated onto the same LED board. The male board-to-board connector 1905 mates directly with female connector on the driver board 125. In a preferred embodiment, there are 76 pins with two rows of 38 pins. This eliminates the need for a cable assembly that is otherwise required and minimizes contact resistance for improved reliability and efficiency. In a preferred embodiment, the metal core PCB is comprised of a base layer of aluminum 1.50 mm thick, with low thermal impedance dielectric between the copper circuit layer and then a second dielectric followed by the top foil layer. The topmost layer is a mask layer. This two-layer circuit is necessary due to having 76 LED die all of which need to be attached to their respect drive channels. By spreading out the heat load, aluminum can be used as the base, which can alternatively be copper. The temperature difference between the base made from copper and that made of aluminum is negligible on the order of one degree Celsius, so there is a distinct benefit to using the lower cost aluminum. The two gold plated copper trace layers may be two ounces. The minimum distance center-to-center of the array elements is 12.0 mm in a preferred embodiment. The large area between LED arrays allows for low heat flux, thereby keeping the LED die junction temperature of all the LED die low. Furthermore, the large Etendue (area, solid angle, index squared product), that is large total die area, and efficient capture of the light from each LED die onto the illumination plane results in low currents per LED die and are generally substantially below the rated currents, which results in further extended lifetime. Holes 1945 and 1950 are kinematic mounts that alight to a pin and diamond shape on the metal housing to maintain alignment between the LED die arrays and the taper array.

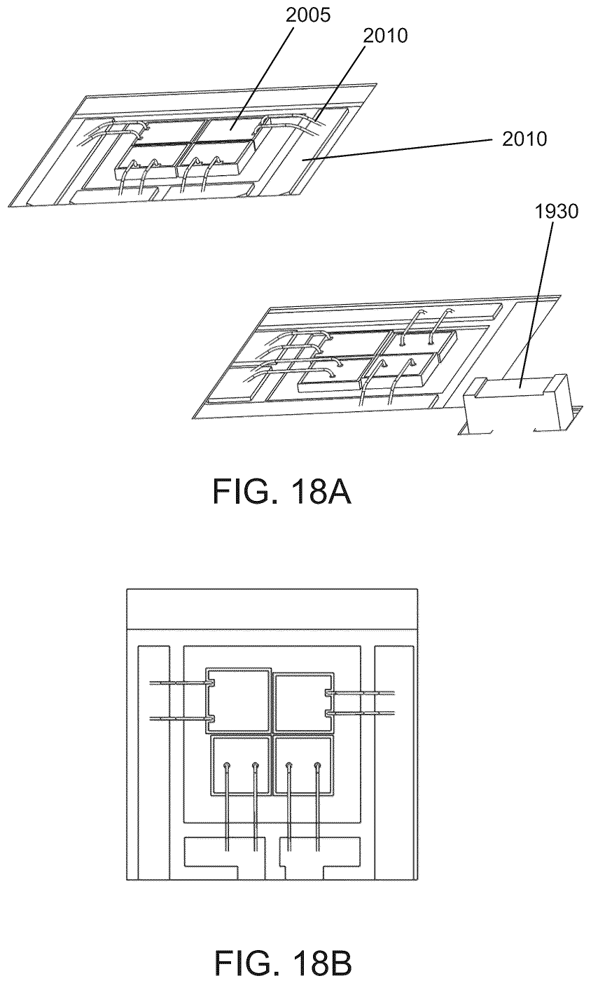

FIG. 18A shows a diagrammatic isometric view of two of the LED arrays of the LED board of FIG. 17. FIG. 18B shows a top view of the upper LED array of FIG. 18A. Wire bonds are not required to cross over another LED die. An equivalent Etendue system with a single closely packed LED array is equivalent to a nine-by-nine die array with the four corner LED die and the center LED die removed, which also includes 76 LED die as in this preferred embodiment. The wire bonding, however, is extremely difficult for such a large array and is prone to electrically shorting to adjacent wire bonds and yielding poor reliability. This is not a concern for the present invention. A two-by-two array is preferable over a single LED die per taper. More specifically, using a single LED die with each taper requires 61 tapers elements for nine LED die across the middle, as opposed to seven for the preferred embodiment, and that still results in fewer die and lower total Etendue. If desired, a three-by-three array can be used for each taper of a 19-element array to increase Etendue and increase image size for the same intensity. If desired, the center die can be left blank in each nine LED die array so that no wire bonds need to cross over any die and all LED die are at the periphery for easy wire bonding. The total number of LED die for this configuration is 152, or roughly twice that of the preferred embodiment. Thus, the image increases in size by the order of 40% to achieve the same intensity for the same current density per LED die. The total package size increases by 50% since it increases linearly with LED die array size. Since the LEDs are driven at low currents, alternatively, the current can be increased to bring the illumination area up to 100 mm by 100 mm. Alternatively, using the two-by-two LED array size but increasing to nine elements across the middle for a total of 37 array elements, a total of 148 LED die are used. The increase in linear size is the ratio of nine to seven (29% increase). Thus, the best approach to going to a larger illumination area involves trading off many variables including size, cost, complexity, etc.

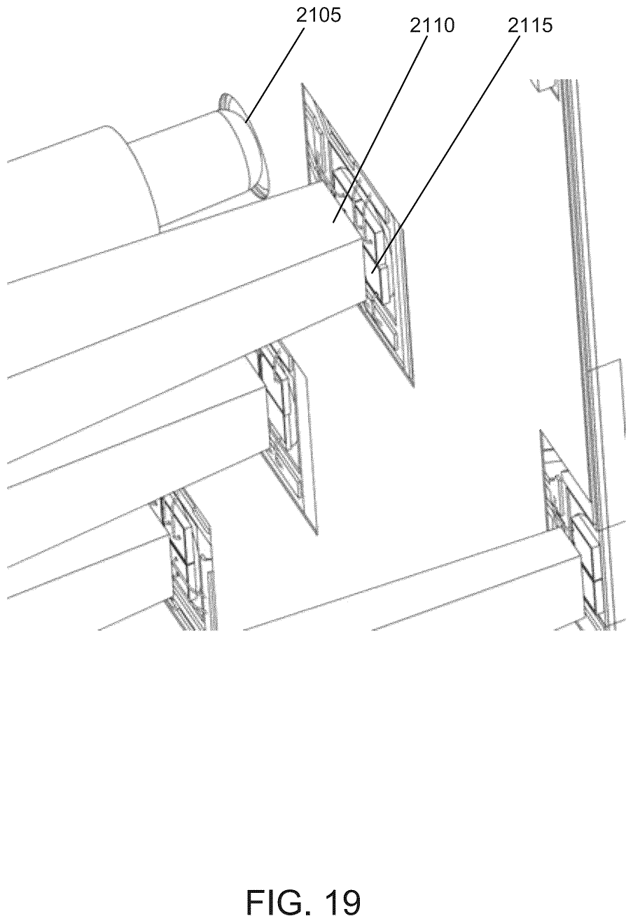

FIG. 19 shows a diagrammatic isometric view of the taper array positioned over LED die arrays. The post of the taper array contacts the circuit layer that the LEDs are attached to at location 2105 to precisely control the gap between the LED die output faces 2115 and the input of the tapers 2110.

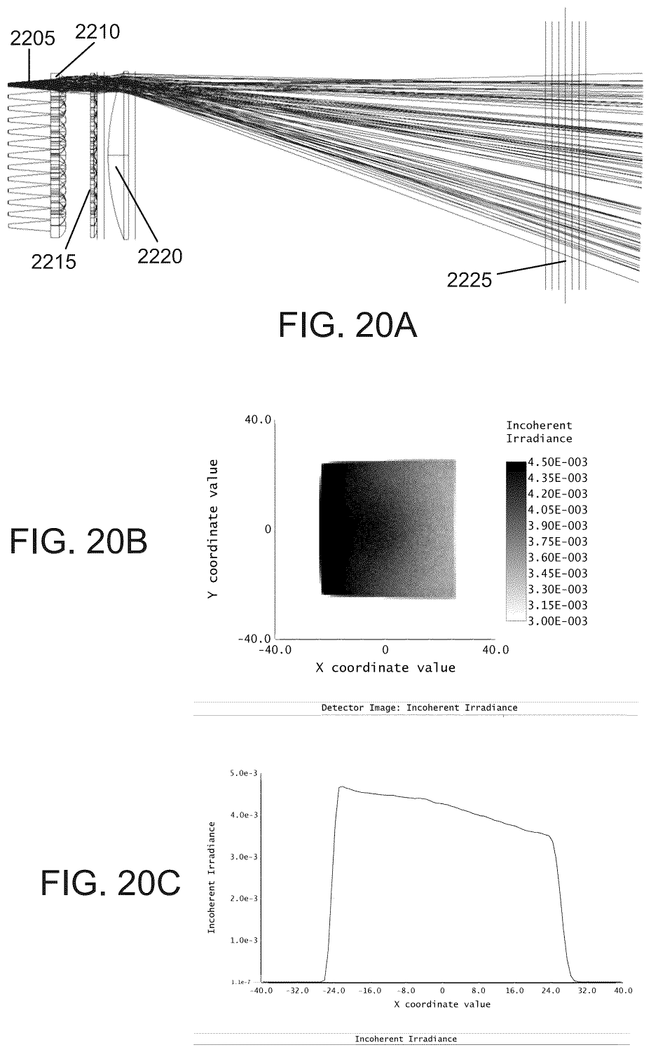

FIG. 20A depicts a non-sequential ray trace of an alternative embodiment of the invention. Taper 2205 is imaged by lens array elements 2110 and 2215 and focused to the illumination plane 2225 by common lens 2220. The purpose of this system is to demonstrate the keystone effect and intensity gradient that results from the off-axis image relative to the center line of the system. FIGS. 20B and 20C show a grey scale image and a profile through the middle, respectively, indicating both the trapezoidal shape of the illumination image and the drop in intensity from top to bottom of the image. This effect is corrected by using a similar wavelength taper output at the diametrically opposite side to balance the two effects. That is the approach used in the preferred embodiment of the system of FIG. 1. However, that requires that there is a smaller total number of LED optical spectra since at least two array elements are required for each optical spectrum. The amount of intensity slope and keystone shown in FIGS. 20A to 20C is much greater than that of the preferred embodiment but is shown for illustrative purposes.

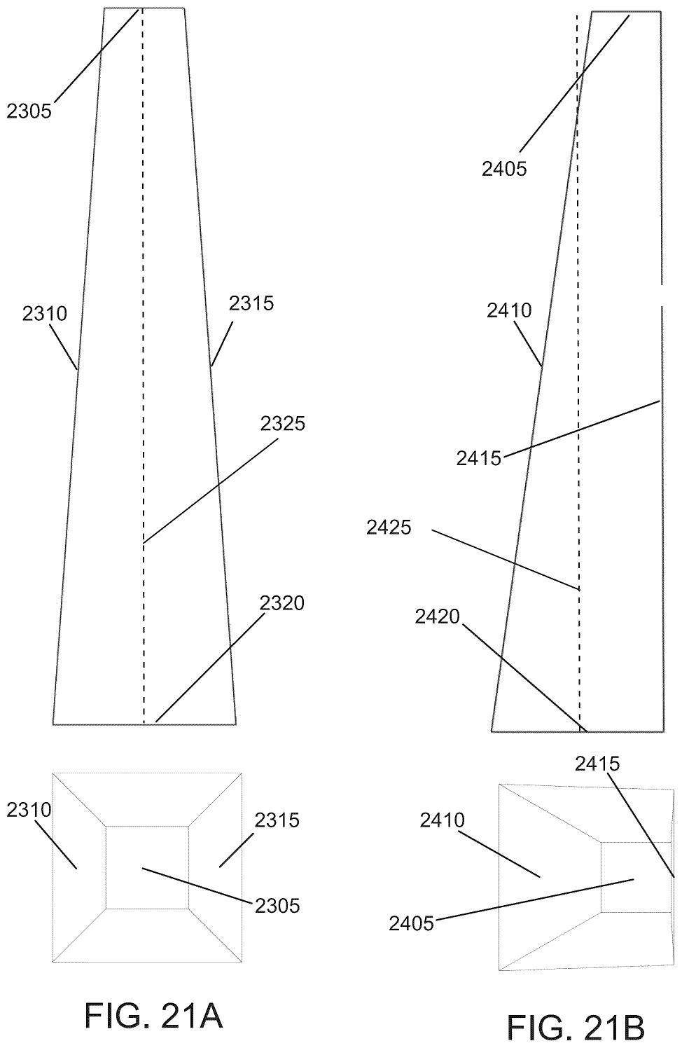

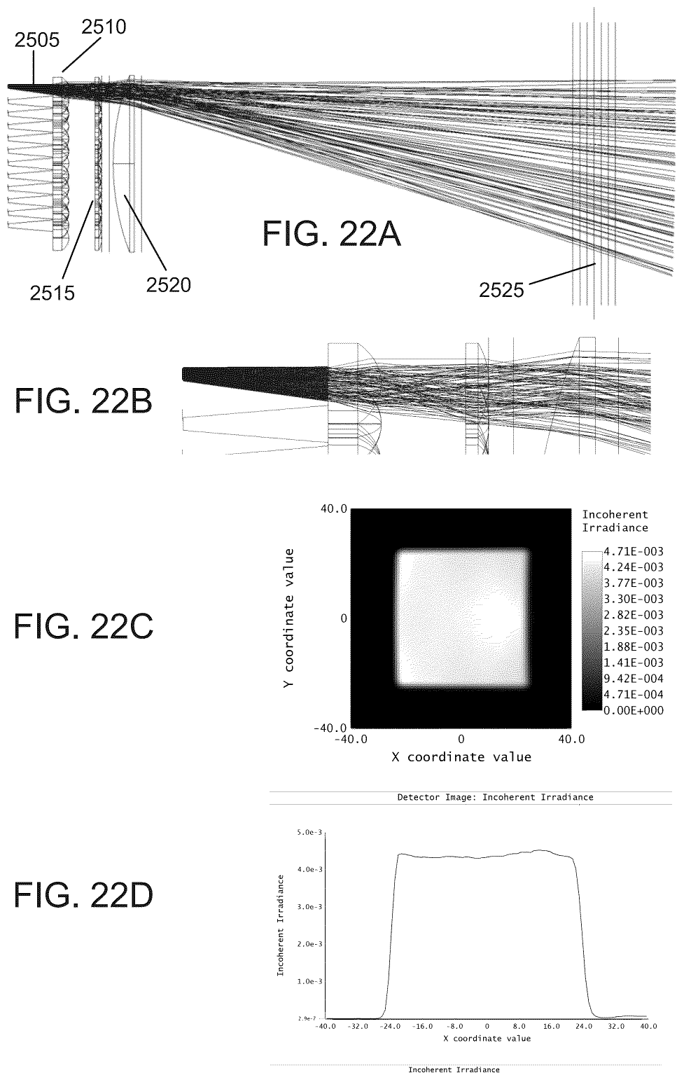

FIG. 21A shows side-on and top-down views of one of the standard taper elements for which the input face 2305 and output face 2320 are orthogonal to and centered on a taper axis 2325. Sides 2310 and 2315 are equal in size and symmetrically opposed. If the position of the input face 2405 is laterally offset relative to the taper axis 2425, as shown in the side-on and top-down views of FIG. 21B, with the bottom of side 2415 at the output face 2420 being slightly smaller than that of side 2410, thereby resulting in a trapezoidal shaped output face 2420, both the keystone and the intensity drop can be compensated. This compensation is illustrated in the ray trace of FIG. 22A with an enlarged view in FIG. 22B showing the asymmetric taper. FIG. 22C shows the resulting grey scale intensity image and FIG. 22D shows a line plot through the center of the grey scale intensity image demonstrating the canceling of effects. The benefit of the asymmetric tapers is that more individual optical spectra are accommodated because symmetrically opposed LED arrays having the same optical spectrum are not required. The drawback of this approach is only in the upfront cost of the tooling which is somewhat greater than for manufacturing symmetric tapers. The amount of lateral offset of the input face 2405 and associated keystone correction is decreased in moving from the outermost tapers to the center taper which lies on the illuminator axis and therefore the associated taper element has no lateral offset of the input face.

In an alternative to the taper element shown in FIGS. 21A and 21B, it should be noted that the input face for the taper element may be centered on the taper axis while the output face is laterally offset from the taper axis. Taper elements configured accordingly can be used to similarly compensate for keystone and intensity gradient at the composite image; however, the spacing between the arrays of LED die would typically increase and may result in an increase in the size of the multispectral illuminator.

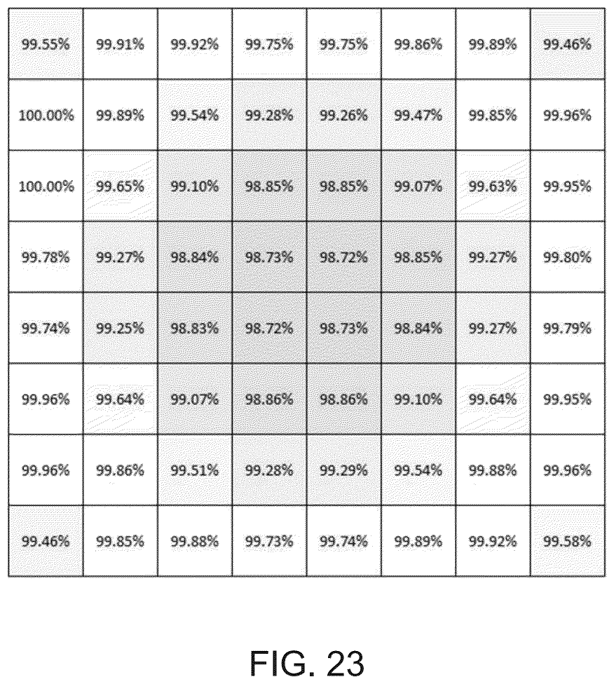

FIG. 23 represents the IEC eight-by-eight grid of detector outputs that result from the system of FIG. 1, for which the intensity nonuniformity is less than one percent giving the system an A⁺ rating for uniformity. Altogether, the unique features of the system of FIG. 1 result in a solar simulator with an A⁺A⁺A⁺ rating, that is the highest performance classification rating available by the IEC standards.

What is claimed is:

1. A multispectral illuminator, comprising:
an array of tapered non-imaging collection optics each having an input face and an output face;
for each of the tapered non-imaging collection optics, an array of LED die disposed proximate to the input face, wherein each LED die has an optical spectrum; and
a lens system configured to receive light emitted from the output faces of the tapered non-imaging collection optics and to generate a composite image at an illumination plane, the composite image comprising an image of each output face at the illumination plane wherein the images are superimposed on each other.

2. The multispectral illuminator of claim 1, further comprising a control module in communication with the arrays of LED die, the control module configured to control an intensity of each LED die and wherein the control module is programmable to provide a predetermined optical spectrum for the composite image.

3. The multispectral illuminator of claim 2, wherein the control module comprises one or more current drivers to supply an electrical current to the LED die.

4. The multispectral illuminator of claim 1, wherein, for each array of LED die, the optical spectrum of at least one of the LED die is different from the optical spectrum of at least one other LED die in the array.

5. The multispectral illuminator of claim 1, wherein, for each array of LED die, all of the LED die have a same optical spectrum.

6. The multispectral illuminator of claim 1, wherein the lens system comprises at least one lens array disposed proximate to the output faces of the array of tapered non-imaging collection optics and is configured to image each of the output faces to infinite and wherein the lens system further comprises at least one lens disposed to receive light from the at least one lens array and to generate the composite image at the illumination plane.

7. The multispectral illuminator of claim 6, wherein the at least one lens array comprises a lens array having a plurality of lenses each having an aspheric surface.

8. The multispectral illuminator of claim 1, wherein, for each LED die in each array of LED die for a tapered non-imaging collection optic that is positioned off axis in the multispectral illuminator, the optical spectrum of the LED die is the same as an LED die in the array of LED die for a diametrically-opposite one of the tapered non-imaging collection optics.

9. The multispectral illuminator of claim 1, wherein the array of tapered non-imaging collection optics is a hexagonal array.

10. The multispectral illuminator of claim 1, wherein the array of tapered non-imaging collection optics is centered on an illuminator axis and each tapered non-imaging collection optic has a taper axis extending between and orthogonal to the input and output faces, and wherein, for each of the tapered non-imaging collection optics that is offset from the illuminator axis, a center of the input face is laterally offset from the taper axis.

11. The multispectral illuminator of claim 10, wherein the output face for each of the tapered non-imaging collection optics that is offset from the illuminator axis has a trapezoidal shape.

12. The multispectral illuminator of claim 10, wherein the lateral offset of the center of the input face from the taper axis is determined by the amount of the offset of the tapered non-imaging collection optic from the illuminator axis.

13. The multispectral illuminator of claim 1, wherein the array of tapered non-imaging collection optics is centered on an illuminator axis and each tapered non-imaging collection optic has a taper axis extending between and orthogonal to the input and output faces, and wherein, for each of the tapered non-imaging collection optics that is offset from the illuminator axis, a center of the output face is laterally offset from the taper axis.

14. The multispectral illuminator of claim 13, wherein the output face for each of the tapered non-imaging collection optics that is offset from the illuminator axis has a trapezoidal shape.

15. The multispectral illuminator of claim 13, wherein the lateral offset of the center of the output face from the taper axis is determined by the amount of the offset of the tapered non-imaging collection optic from the illuminator axis.

16. The multispectral illuminator of claim 1, wherein at least one of the tapered non-imaging collection optics is a hollow tapered non-imaging collection optic.

17. The multispectral illuminator of claim 16, wherein the hollow tapered non-imaging collection optic includes a high reflectance surface.

18. The multispectral illuminator of claim 1, wherein at least one of the tapered non-imaging collection optics is formed of a molded plastic.

19. The multispectral illuminator of claim 1, wherein at least one of the tapered non-imaging collection optics is formed of an ultraviolet transmitting material.
